(19) United States
(12) Patent Application Publication
(10) Pub. No.: US 2005/0128121 A1
(43) Pub. Date: Jun. 16, 2005

(54) Indash car stereo combined with speed detection device

(76) Inventor: Kevin James Kroculick, Harrisburg, PA (US)

Correspondence Address: Kevin Kroculick, 115 Ringneck Drive, Harrisburg, PA, 17112, US

(21) Appl. No.: 10/941,405

(22) Filed: Sep. 15, 2004

Related U.S. Application Data
(63) Continuation-in-part of application No. 10/736,039, filed on Dec. 15, 2003, now abandoned.

(51) Int. Cl. G01S 7/40

(52) U.S. Cl. 342/20; 342/175; 342/52

(57) ABSTRACT

The Indash Car Stereo Combined With Speed Detection Device is generally comprised of a conventional indash automobile stereo system that has police radar detection capabilities. When police radar is detected, the stereo's volume is immediately muted. An audible alert is then outputted through the vehicle's speaker system or a built-in speaker on the control panel, or a combination of both, depending on how the driver has it configured. A visual alert is also produced on the control panel, which displays the band of radar that was encountered, and its relative signal strength. The radar detector receives signals from the vehicle's antenna and an auxiliary antenna. The auxiliary antenna is attached to the vehicle's grille. This improves the signal reception ability. The present invention eliminates many drawbacks associated with conventional radar detector units, such as their obviousness which has tendency to attract thieves and vandals if left unattended; their inconsistent effectiveness caused by impeded reception ability when they are mounted improperly; their bulkiness; and potential to produce visual impairment and distraction.

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISC.

N/A

### REFERENCE TO A MICHROFISHE APPENDIX

N/A

### BACKGROUND OF THE INVENTION

(1) Field of Invention

The present invention relates to an Indash Car Stereo Combined With Speed Detection Device. More specifically, it combines a typical indash type car stereo, with a radar detector of the type that is used for detecting police radar of the sort used in radar speed traps on public roads. When the police radar is detected, the stereo volume is muted and an audible warning sound is emitted from the vehicle's speakers.

(2) Description of Related Art

Including information declared under 37 CFR 1.97 and 1.98.

Typical radar detectors are effective and function properly if the manufacturers instructions are followed. However, there are many drawbacks associated with the use of typical radar detectors. This invention eliminates those associated problems in a convenient, practical, and relatively inexpensive manner.

The bulkiness of conventional radar detectors may be a hindrance to vision, or it may be otherwise undesirable from an esthetic point of view. Also, if a conventional radar detector is left in the vehicle unattended, its obviousness makes it vulnerable to theft. Furthermore, the theft of a radar detector usually results in vandalism to the vehicle.

Of course to reduce the chance of theft, the vehicle's operator can install the radar detector before each trip, then remove and store it after the trip is complete, but this is time consuming and cumbersome.

From a more scientific point of view, microwave frequencies of those used in police radars travel in a straight Line. These microwave frequencies will pass through many plastic materials and glass, but will not pass through metal objects or mirrors. Therefore, in order for a radar detector to function properly, the microwave radar transmission must have a favorable path from its transmitter to the receiver.

In the present invention, the radar detector portion of the device receives signals from the vehicle's antenna. This configuration vastly improves the signal reception ability compared to conventional horn or microstrip antennas associated with conventional radar detector units. The present invention also provides for an additional auxiliary antenna that is attached to the vehicle's grille, further enhancing its signal reception ability.

When a police radar signal is detected, the present invention can respond in a variety of ways, depending on how the operator has it configured. The most common response scenario when a police radar signal is detected is the stereo volume is immediately muted, a warning tone momentarily emanates from the vehicle's speakers and/or a small, built-in speaker located on the control panel, and a momentary visual alert is displayed on the control panel. After several seconds, the stereo resumes its normal operation. The ability of the stereo to immediately mute and emit a momentary warning tone from the vehicle's speakers and provide a visual alert from the control panel when police radar is detected, combined with the enhanced radar reception capability, are key elements of the present invention.

In short, integrating the radar detector into a car stereo system reduces the potential for theft and its associated vandalism, increases the radar detector's effectiveness, and eliminates the need for a nuisance power cord.

It is imperative to note that radar detectors are not intended to encourage the vehicle's operator to drive faster than the posted speed limit. Radar detectors, when used responsibly, actually make drivers more cognizant of their speed, warn drivers of roadwork construction sites, and produce a feeling of safety and confidence when driving in unfamiliar territory. The present invention is also not intended to encourage the driving of vehicles while playing the stereo in a very loud manner. The present invention is also not a police radar jamming system, as these are illegal in many states.

Many people own radar detectors. However, their frequency of usage has a tendency to fade with time. The reason is because most radar detectors require the operator to plug the power cord into the cigarette lighter socket, and then mount the unit on the visor, windshield, or dashboard. This is time consuming and frustrating, especially during cold weather conditions. Furthermore, mounting the unit on the dashboard with Velcro™ is usually permanent, as removing the Velcro™ pad may permanently scar the dashboard surface.

Another common complaint related to conventional radar detectors is that the power cord is unsightly, reduces visibility, and is a distraction.

Of course to reduce the threat of theft, a person can remove and store the radar detector out of view. However, removing the radar detector requires unplugging the power cord, returning the cigarette lighter to its housing, removing the radar detector from its mount, then storing it in a secure place such as the truck or glove compartment.

Conventional radar detectors have other disadvantages. Another drawback is the possibility the audio alert will not be heard over a very loud stereo. When this occurs, the entire use of the radar detector has been negated.

Another drawback is that it is sometimes difficult to mount the detector unit in a convenient place that also provides for good microwave radar reception. Because police radar guns work on the line-of-sight principle, it is necessary to provide for a clear, unimpeded path between the radar detector and the radar emitter. A radar detector that does not have the opportunity to detect the police radar is valueless. The present invention solves the above noted problems associated with conventional radar detector configurations.

Incorporating the radar detector into a conventional car stereo system and providing for integrated circuitry to interface with the stereo portion, and providing a means to utilize the vehicle's radio antenna, and providing for additional auxiliary antenna, has many advantages. This configuration reduces the possibility of theft by making the radar detector less obvious. It also makes the radar detector more effective by vastly improving its signal reception capabilities by utilizing the vehicle's radio antenna and providing for an auxiliary antenna that is mounted on the vehicle's grille. It also ensures that the driver is adequately alerted to the presence of police radar guns by momentarily muting the stereo sound, and producing a visual alert on the control panel. This configuration is also much more convenient and esthetically pleasing than conventional radar detectors because there is no need to mount the detector, which in turn eliminates the disadvantage of having a power cord dangling in the vehicle's cabin. Thusly, drivers are more inclined to utilize the radar detector because of its convenience and ease of use.

With respect to specific prior art, some radar detector models provide for a remote antenna to be located in the vehicle's engine compartment. These models provide for unobstructed exposure to the radar emitters, but again the detectors bulkiness and associated annoying power cord are a disadvantage.

U.S. Pat. No. 4,625,210 is a portable radar detector that is attachable and detachable to the rearview mirror. This invention provides for unobstructed exposure to front and rear microwave frequency radar transmissions.

Several other attempts have been made to improve radar detectors. U.S Pat. No. 4,631,542 to Grimsley eliminates annoying prolonged audible alerts.

U.S. Pat. No. 4,887,086 to Unser et al is portable device that combines a radar detector with a typical citizen band radio and scanning receiver. Under the control of a microprocessor, a detected traffic radar signal will temporarily override the signal being heard unless the operator elects otherwise.

U.S. Pat. No. 4,906,999 to Harrah et al is device that detects the proximity of certain aircraft. This invention useful in determining whether an aircraft may be engaged in speed detection operations.

U.S. Pat. No. 5,220,685 to Bradt et al is a device that mutes out unwanted messages being received by a radio communication receiver. The operator must select a push button to mute the wanted sound, but the voice or code conversion will automatically reset after a set amount of time.

U.S. Pat. No. 5,250,951 to Valentine et al is a police radar detector that is capable of detecting multiple radars and determining the direction from which the signal originated.

U.S. Pat. No. 5,735,491 to Atkinson discloses a safety device designed to alert a driver to an approaching train by detecting the brake status signal.

U.S. Pat. No. 6,078,279 to Oliva is a typical radar detector that provides a muting means, and more particularly, to a signal detector which initiates a muted alarm upon detection of a second, subsequent signal.

Several U.S. patents have been granted relating to improvements to car stereo lighting and control display features. These include U.S. Pat. No. 5,363,122, which relates to a System For Controlling A Display On A Car Stereo, and U.S. Pat. No. 6,065,868, which relates to a Temperature Display For A Car Stereo.

### BRIEF SUMMARY OF THE INVENTION

Summarized briefly, the principle object of the present invention is to combine a modern means of detecting highway speed control radar emitters with a typical indash type car stereo system. This combination is known as the Indash Car Stereo Combined With Speed Detection Device.

The device is comprised of a housing adapted for mounting into the dashboard of a motor vehicle. The stereo portion consists of an amplifier provided within the housing for receiving, generating, and amplifying audio signals of an AM/FM tuner, and at least one of a cassette tape, MP3, or Compact Disk player. The AM/FM tuner is capable of receiving and processing the typical FM radio bandwidth of 87.40 MHz to 108.10 MHz, and the typical AM radio bandwidth of 510 KHz to 1710 KHz.

The radar detector portion is comprised of a typical police radar detecting means for detecting the presence of radar signals. The radar detector portion is electrically integrated into the stereo amplifier portion with electronic interface logic means. Both the interface logic means, radar detector means, and stereo amplifier, communicate with at least one of the vehicle's speakers and a small built in speaker located on the control panel, which is capable of producing audible alerts, and Light Emitting Diodes (LEDs) or a Liquid Crystal Display (LCD) located on the control panel which are capable of providing a visual warning when police radar signals are detected.

A key feature of the present invention is that the stereo sound is immediately and automatically muted when police radar signals are detected. Another key element is that it provides for at least one jack input on the housing to receive the auxiliary antenna jack. The auxiliary antenna preferably mounts on the vehicle's grille with adhesive or other bonding means. A standard jack input is also provided on the housing, which receives the vehicle's antenna wire.

When police radar signals are detected, the stereo volume is automatically muted and an audible alarm is emitted, at a preset volume, from the vehicle's speakers. A small built-in speaker is provided on the control panel, which can also emit an audible warning if activated. The built-in speaker, and the vehicle's speakers, can be used in conjunction with each other, or independently, to produce the audible alert. LEDs or a LCD on the control panel also provide the driver with a visual alert when police radar is detected. The visual alert means can be used in conjunction with, or independently of the audible alert means.

The radar detector communicates with the vehicle's radio antenna and auxiliary antenna located on the vehicle's grille, greatly improving its reception capabilities. The auxiliary antenna is installed through an opening in the vehicle's firewall, and mounted on or near the vehicle's grille with adhesive or other bonding means.

The driver can operate the stereo in combination with, or independently of, the radar detector. Consequently, the driver can choose to only operate the stereo, while the radar detector portion is deactivated. The driver can also choose to only operate the radar detector portion without utilizing the stereo portion.

Accordingly, a radar detector integrated into a typical car stereo system provides the driver with both stereo and radar detection capability, without the many disadvantages of having an independent radar detector.

Therefore, it is an objective of the present invention to eliminate the need to install/uninstall a radar detector prior to and after each trip.

Another object of the present invention is to make its radar detector portion much less obvious than a separate, conventional radar detector to reduce the potential for theft and vandalism, and eliminate the power cord, which is a visual distraction.

Another object is to utilize the vehicle's antenna to increase its radar detection capabilities.

Still another object is to provide for auxiliary antenna to increase its radar detection capabilities.

The system's ability to override and automatically mute the stereo amplifier system, and the ability to use the stereo portion or radar detector portion independently, enables each driver to regulate the system as desired. This flexibility is an object of the present invention.

Radar emitters are usually installed at road construction sites to warn drivers of roadwork. Therefore, another object of the present invention is to increase driver awareness and safety.

### BRIEF DESCRIPTION OF THE SEVERAL VIEWS OF THE DRAWINGS

While the invention is particularly pointed out and distinctly claimed in the concluding portions herein, a preferred embodiment is set forth in the following detailed description which may be best understood when read in connection with the accompanying drawings, in which:

FIG. 1 shows a schematic block diagram of the invention.

FIG. 2 shows a preferred embodiment of the front panel of the invention.

FIG. 3 shows a preferred embodiment of the auxiliary antenna.

FIG. 4 shows the invention mounted in the dashboard of a typical automobile.

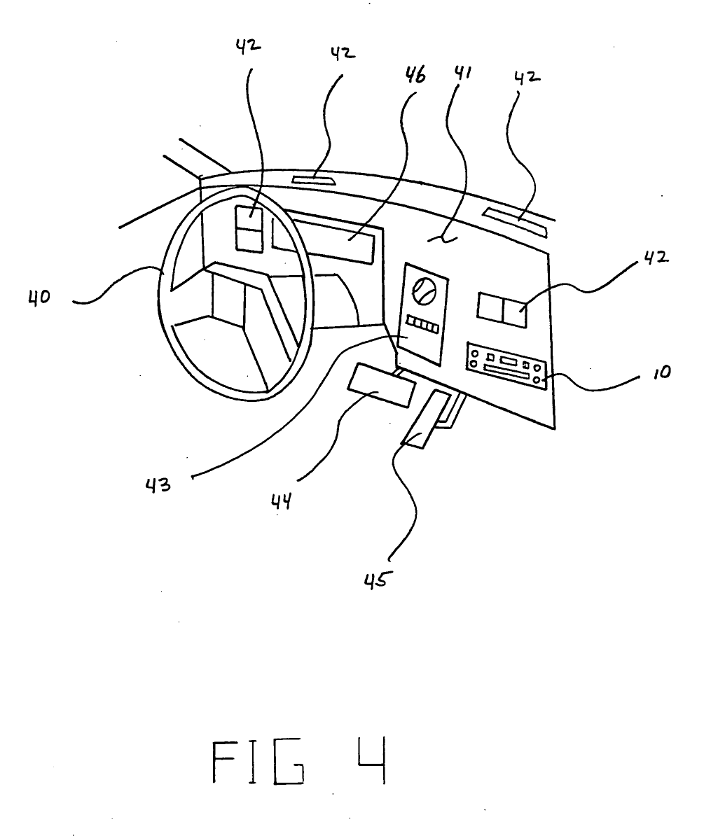

FIG. 5 shows a rear isometric view of the invention.

FIG. 6 shows an isometric view of a typical vehicle with auxiliary antenna installed.

### DETAILED DESCRIPTION OF THE INVENTION

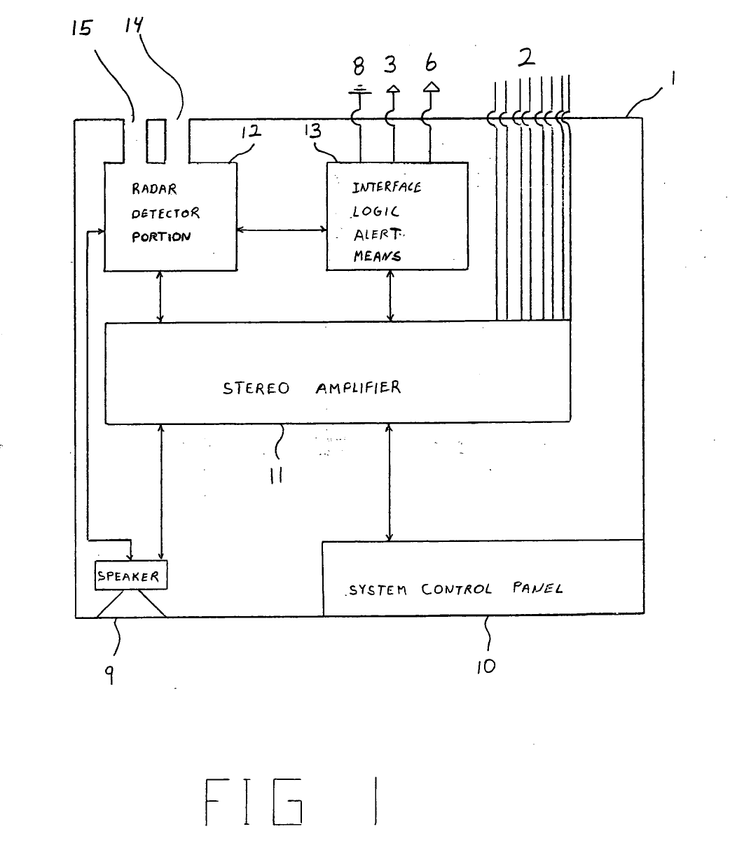

FIG. 1 shows a block diagram of the present invention. The present invention is comprised of a housing 1, speaker wires 2, constant power connection 3, accessory power connection 6, and ground connection 8. The present invention is also comprised of a stereo amplifier 11, connected to means for generating audio signals consisting of an AM/FM tuner, and at least a tape, Compact Disc, and MP3 player, and associated system control panel 10. A radio antenna jack 15 that receives the vehicle's antenna wire is also provided. This configuration is similar to that of modern, conventional indash style car stereo system.

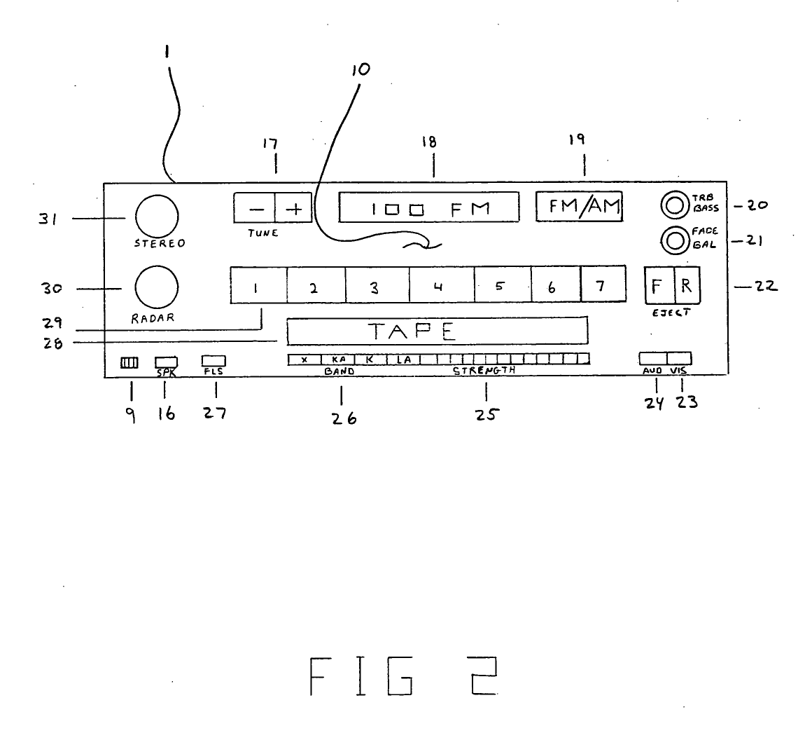

The system control panel of the present invention is shown in FIG. 2. The control panel 10 is comprised of buttons, knobs, and selectors, which allows the operator to control the stereo amplifier, such as the power (on/off), volume 31, AM/FM selector 19, channel indicator 18, radio present selector buttons 29, balance and fade 21, tuner 17, tone (bass and treble) 20, and the like. It provides for a tape, compact disc and/or MP3 player means 28 and associated controls, such as fast forward and reverse eject buttons 22. This basic control panel configuration is also similar to that of many conventional car stereo systems.

However, the present invention concerns the addition of a feature to the typical indash car stereo system that is capable of alerting the vehicle's operator when police radar is detected. This is primarily accomplished by incorporating radar detector portion 12 in the housing 1, and providing for interface and logic alert means 13, which interfaces with the other circuits and at least one of the vehicle's speakers 47.

Summarized briefly, police radar involves transmitting microwave signals at a target and receiving them back at the transmitter. The speed at which the signal returns relative to the speed at which is was transmitted determines the objects speed. This process is known as the Doppler effect. Police radar is generally transmitted on three frequency bands: X band is 10.50-10.55 GHz, K band is 24.05-24.25 GHz, and Ka Superwide band is 33.40-36.00 GHz. Some states also use lasers to determine a vehicle's highway speed. Transmissions at those frequencies will pass through certain kinds of materials that are substantially transparent to them, such as glass and most plastics, but not other kinds of materials, such as metal. In general, microwave frequencies at those frequencies travel in a straight line and must have an unrestricted exposure to the antenna in order for the radar detector to function properly.

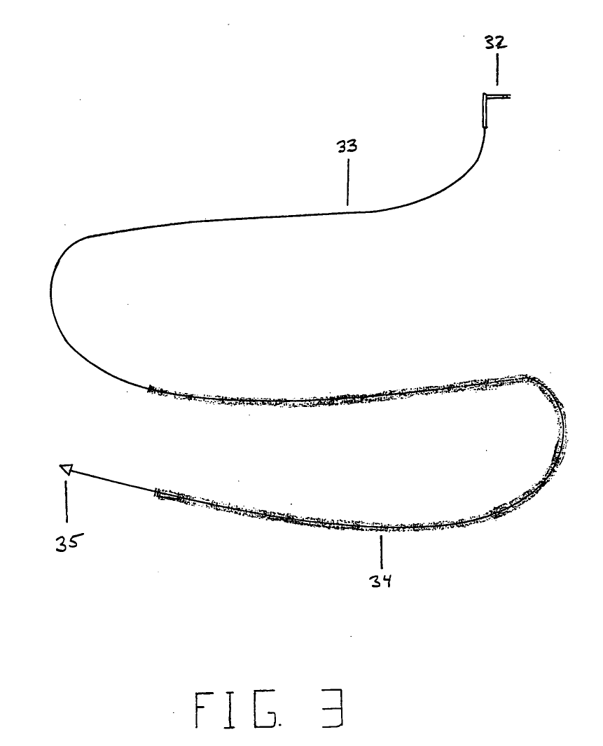

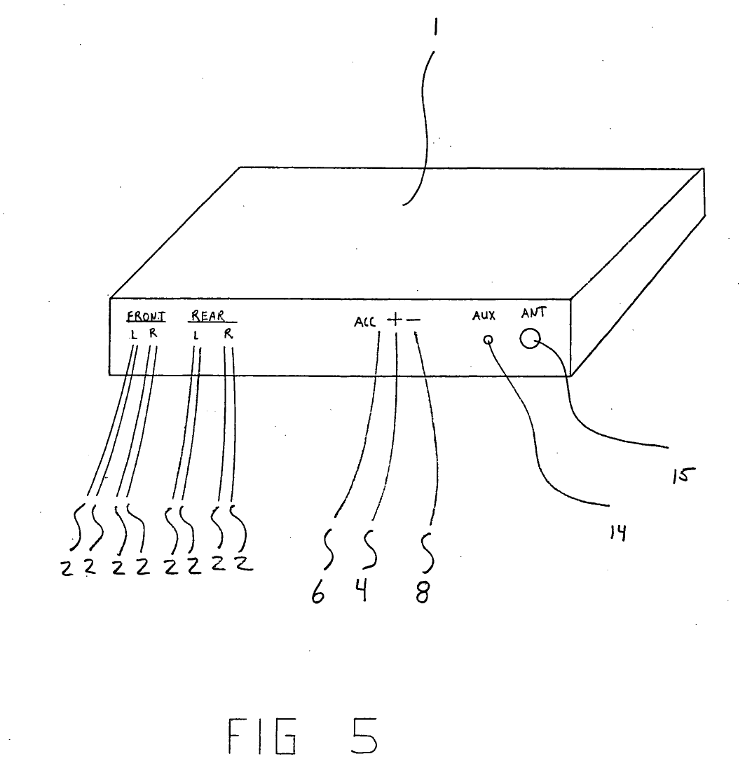

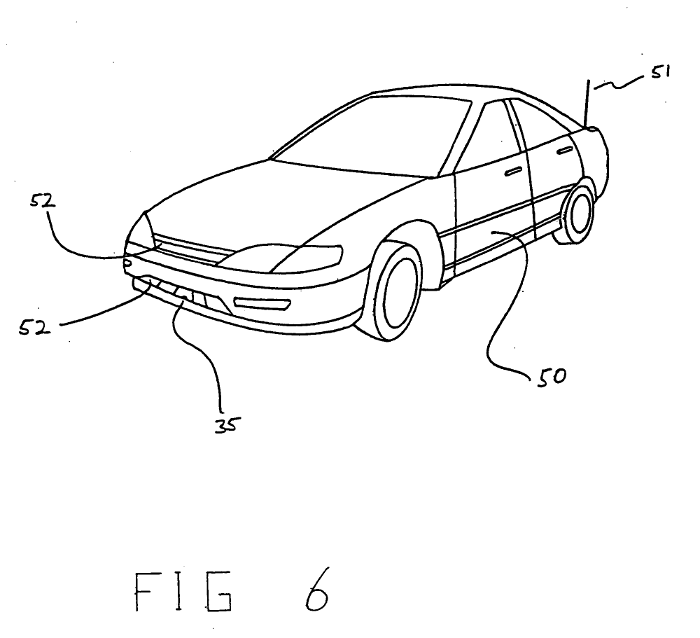

It is these characteristics that are particularly taken advantage of by the present invention. In the present invention, police radar transmissions are received by the radio antenna 51, which is provided on the typical vehicle 50. This configuration is shown in FIG. 6. This configuration vastly improves police radar reception capability. Furthermore, an auxiliary antenna is also provided. The auxiliary antenna is shown in FIG. 3. The antenna 35 is mounted on the vehicle's grille 52 with adhesive or other suitable bonding means and is small enough to be virtually unnoticeable. An antenna wire 33 comprised of a prong 32 and protective sleeve 34 is installed through the vehicle's firewall, and is received by the antenna jack 14 located in the housing. Therefore, providing for a grille mounted auxiliary antenna in conjunction with utilizing the vehicle's radio antenna to receive microwave transmissions maximizes the probability that a police radar signal of interest will be received. The rear isometric view is shown in FIG. 5.

Another key element to the present invention is the manner in which it alerts the driver to the presence of police radar. When the vehicle's radio antenna or the auxiliary antenna receives a police radar transmission, the signal is transmitted to the radar detector portion. The radar detector portion has circuitry similar to that of modern police radar detectors. The circuitry has bandwidths set to the frequencies of interest. If a signal is within the acceptable target range and bandwidth of the true frequency and is encountered at acceptable amplitude, then the radar detector determines that a valid police microwave transmission has been encountered. The radar detector portion then immediately communicates with the interface logic means. The interface logic means then communicates with, and instructs the stereo amplifier to immediately alert the driver by implementing conditions that were pre-set by the driver.

The present invention can be operated in three primary modes. First, the radar detector portion can be activated while the stereo is deactivated, second, the stereo portion can be activated while the radar detector portion is deactivated, and third, the radar detector portion and stereo portion can be operated simultaneously.

As noted above, the driver may elect to operate the radar detector portion while the stereo portion is tuned off. In this mode, the operation of the radar detector is similar to that of a conventional radar detector, but with improved reception capabilities. The driver selects this mode by turning the stereo off with the associated power and volume control 31. The driver must also activate the radar detector by selecting the associated radar power and volume control 30.

The radar detector button adjusts the volume of the audible alert that emanates from the vehicle's speakers when police radar is detected. In the event the driver prefers not to utilize the vehicle's speakers, the Indash Car Stereo Combined With Speed Detection Device provides a built-in speaker 9. Selecting the speaker control 16 on the control panel activates this speaker. Deselecting the radar audio control 24 prevents the vehicle's speakers from emitting an alert when police radar is encountered. The speaker button also adjusts the built-in speaker volume; continually holding the button in increases the alert sound. When the desired volume is reached, the button is released. This volume setting is retained until the driver makes an adjustment. The built-in speaker has a maximum volume; holding in the speaker button will escalate the volume to its maximum level, but the volume will then gradually decline. This high low cycle is repeatable.

Also in this mode, the driver may also activate the visual alert portion located on the control panel by selecting the visual on/off control 23. These visual alerts are comprised of LEDs or LCDs and illuminate when police radar is encountered. These visual alerts display the band type that was transmitted on the band indicator 26, and display its relative signal strength on the strength indicator 25. The visual alert portion may be operated in conjunction with the audio alert, or independent of the audio alert.

Another operating mode consists of utilizing the stereo while the radar detector portion is deactivated. This can be accomplished by activating the stereo by selecting the appropriate stereo power and volume control 31, while deactivating the radar power volume control 30. The present invention operates as a conventional car stereo in this configuration.

The third mode, and most common mode of operation, is to operate the radar detector portion and stereo simultaneously. This mode provides the driver with both conventional car audio sound, and police radar detection capability.

In this mode, the driver selects the radar power and volume control 30 and stereo power and volume control 31. When police radar is detected, the stereo volume momentarily mutes, and an audible warning is sent to the vehicle's speakers 47. The driver may also elect to have the audible warning sent to the built-in speaker located on the control panel, or the driver may elect to have the audible warning sent to only the built-in speaker, depending on preference. In any case, the stereo resumes its normal play after the momentary audible alert is heard. In this mode, the driver may also activate the visual alert portion, or only have the visual alert portion activated, depending on preference.

As mentioned above, an auxiliary antenna shown in FIG. 3 is also provided. The auxiliary antenna 35 is mounted on the vehicle's grille.

The auxiliary antenna wire 33 is inserted through the vehicle's firewall, and the prong 32 is inserted the auxiliary antenna jack 14. A typical protective sleeve 34 made of high strength and heat resistant material is provided to eliminate potential damage to the antenna wire. Because the auxiliary antenna is mounted on the grille, where the police radar is aimed, it provides for exceptional radar detection capability.

Many security systems, garage door openers, etc. can produce false alerts. Consequently, a means to eliminate unwanted audio alerts is provided. When the false signal selector 27 is selected, pre-set signal amplitude must be reached before the alert activates. If the driver chooses not to utilize the radar detector portion, then it can be easily turned-off by making the appropriate selection on the power and volume button 30. Likewise, the radar detector portion can be activated without listening to the stereo.

When the radar detector portion is activated, it can perform a self-test. This entails an internal operational check accompanied by a momentary illumination of the LEDs and a brief audio alert.

The present invention is ultimately mounted into the vehicle's dashboard 41, which makes its use very convenient for the driver, as shown in FIG. 5. A steering wheel 40, air vent 42, and control panel 43, brake pedal 44, accelerator pedal 45 and dashboard indicator panel 46 are shown for reference.

Although preferred embodiments of the invention have been described in the foregoing Detailed Description of the Invention, it will be understood that the invention is not limited to the embodiments disclosed, but is capable of numerous rearrangements, modifications, and substitution of parts and elements without departing from the spirit of the invention. For example, each radar band detected can produce a separate audio alert, such as a chirp, ring, or shrill sound. The device could provide for police laser detection, or radar detection, detection, have XM stereo capabilities, or have anti theft protection. The switches and buttons may be placed in different positions, or eliminated without affecting the purpose of the assembly and the invention. An anti-theft detachable control face may also be provided. A remote control device may be provided. Accordingly, the present invention is intended to encompass such rearrangements, modifications, and substitutions of parts and elements as fall within the scope and spirit of the claims.

1). An Indash Car Stereo Combined With Speed Detection Device comprising; a police radar detector integrated into a typical indash car stereo for use in motor vehicles having an existing dashboard, radio antenna, and stereo speakers, consisting of:
a) a housing adapted for mounting said device into the dashboard of a motor vehicle;
b) an amplifier provided within said housing for amplifying audio signals;
c) means for generating audio signals electrically connected to said amplifier;
d) radar detector means for detecting the presence of police radar signals provided within said housing;
e) at least one vehicle stereo speaker electrically connected to said amplifier for producing audible sounds;
f) a speaker within said housing electrically connected to said amplifier for producing audible warning sounds;
g) interface logic alert means electrically connected to said radar detector means and said means for generating audio signals for providing at least one of a visual warning signal and audible warning signal when radar signals are detected; and
h) muting means for reducing the level of sound provided to said at least one speaker from said means for generating audio signals whenever said radar detector means detects the presence of police radar signals.
Whereby said integrated stereo and police radar detector eliminates the need for a separate police radar detector and associated power cord; eliminates the need to install and uninstall a separate, conspicuous radar detector before and after each trip; eliminates the radar detector's obviousness which reduces visual impairment while reducing the chance of theft; provides for enhanced radar detection by utilizing the vehicle's antenna, and providing for an auxiliary antenna that mounts to vehicle's grille; momentarily mutes the stereo when police radar is detected; utilizes the vehicle's stereo speakers to emit an audible alert when police radar is detected; produces audible and visual alerts from said housing as desired; provides for the ability to operate the radar detector and stereo independently, or in combination; promotes safer travel by alerting drivers to road hazards (when roadside DOT warning systems are available); and encourages safer travel by making drivers conscious of their speed.

2). The device according to claim 1 wherein said device is connected to at least one of said vehicle's stereo speakers.

3). The device according to claim 1 wherein said plurality of speakers are mounted at various desired locations within said vehicle, and at least one speaker is provided within said housing.

4). The device according to claim 1 wherein said means for generating audio signals is provided within said housing.

5). The device according to claim 1 wherein said means for generating audio signals further consists of an AM/FM tuner, capable of receiving and processing at least the typical FM radio bandwidth of 87.40 MHz to 108.10 MHz, and the typical AM radio bandwidth of 510 KHz to 1710 KHz.

6). The device according to claim 1 wherein said means for generating audio signals further consists of at least a cassette tape player, Compact Disk player, and MP3 player.

7). The device according to claim 1 wherein said radar detection means is integrated into said amplifier, and is capable of receiving and processing at least the typical X, K and Superwide Ka police radar detector band frequencies of 10.50-10.55 GHz, 24.05-24.25 GHz, and 33.40-36.00 GHz, respectively.

8). The device according to claim 1 wherein said vehicle's primary antenna is mounted on an upper surface of said vehicle, wherein said device has a first antenna input jack adapted to receive an electrical connection from said primary antenna.

9). The device according to claim 1 further comprising an auxiliary antenna mounted on a front grille of said vehicle, wherein said device has a second antenna input jack adapted to receive an electrical connection from said auxiliary antenna.

10). The device according to claim 1 wherein said interface logic alert means provides an audible warning signal to said at least one vehicle speaker, and wherein said muting means reduces the level of sound provided to said at least one speaker from said means for generating audio signal to a zero output, thus allowing the amplifier to amplify only the audible warning signal.

11). The device according to claim 1 wherein said interface logic alert means further provides an audible warning signal to speaker within said housing.

12). The device according to claim 1 wherein said audible alert means is electrically connected to said at least one vehicle speaker, and wherein said muting means reduces the level of sound provided to said at least one speaker from said means for generating audio signal to a zero output, and said audible warning signal to speaker within said housing can be operated independently, or in combination.

13). The device according to claim 1 further comprising a display means provided on said housing to display operational status of said radar detector means.

14). The device according to claim 1 further comprising a display means provided on said housing to operational status of said audio signal generating means.

15). The device according to claim 1 further comprising a display means provided on said housing to display said visual warning signal from said alert means, and wherein said audible warning signals are simultaneously provided to said at least one vehicle speaker and speaker within said housing.

16). The device according to claim 1 wherein said means for generating audio signals can be independently deactivated while said radar detector means remains in an operating condition.

17). The device according to claim 1 wherein said radar detector means can be independently deactivated while said means for generating audio signals remains in an operating condition.

18). The device according to claim 1 wherein the volume of the said means for generating audio alert signal is adjustable.

19). The device according to claim 1 wherein said means for displaying visual alert means is adjustable.
